(19) United States
(12) Patent Application Publication
(10) Pub. No.: US 2015/0138907 A1
(43) Pub. Date: May 21, 2015

(54) MEMBER IN CONTACT WITH RUBBER MATERIAL

(71) Applicant: Kabushiki Kaisha Kobe Seiko Sho (Kobe Steel, Ltd.), Kobe-shi, Hyogo (JP)

(72) Inventors: Shiori Watanabe, Kobe-shi (JP); Koichi Miyake, Takasago-shi (JP); Hodaka Miura, Kobe-shi (JP)

(73) Assignee: Kabushiki Kaisha Kobe Seiko Sho (Kobe Steel, Ltd.), Kobe-shi, Hyogo (JP)

(21) Appl. No.: 14/408,079

(22) PCT Filed: Jul. 16, 2013
(86) PCT No.: PCT/JP2013/004347

§ 371 Date: Dec. 15, 2014

(30) Foreign Application Priority Data
Aug. 7, 2012 (JP) 2012-174920

(51) Int. Cl. B29B 7/62; B29B 7/80

(52) U.S. Cl. CPC B29B 7/62; B29B 7/80
USPC 366/69

(57) ABSTRACT

The present invention provides a member in contact with a rubber material, the member being characterized in that the member has a surface in contact with the rubber material, and that the contact angle of the surface thereof in contact with the rubber material is 40° or more when a liquid rubber to be tested is placed on the surface.

### TECHNICAL FIELD

The present invention relates to a member in contact with a rubber material in performing a processing such as kneading or rolling of rubber.

### BACKGROUND ART

Generally, in manufacturing a rubber product, a rubber material is firstly kneaded, and a processing such as rolling, pressing, or extruding is performed to the kneaded rubber material. A rubber processing apparatus for performing such processing is provided with members in direct contact with the rubber material, including a rolling roll for processing of the rubber material, a press die, a roller of a roller head extruder, and the like. To the surface of these members, it is common to apply chromium plating or the like for inhibiting adhesion of the rubber material.

As a technique to inhibit adhesion of a rubber material, a processing apparatus of Patent Document 1 is known. The processing apparatus of Patent Document 1 is a processing apparatus used in a rubber kneading process and a die setting process, and inhibits adhesion of the rubber material by setting a surface roughness (Ra) of a metal surface in contact with the rubber material to 5-50 μm.

Generally, if the surface roughness Ra of the metal surface is limited and the surface is roughened, it is believed that the contact area of the metal surface with the rubber material is reduced, and that the rubber material hardly adheres to the metal surface. However, in the rubber materials processed by the recent rubber processing apparatuses, silane coupling agent is often mixed in order to enhance the dispersibility of a filler. Such silane coupling agent reacts with not only the filler but also the metal surface in direct contact with the rubber material. Therefore, if the rubber material containing silane coupling agent will be processed by a rolling roll or the like, there will be a problem that the rubber material is adhered to the metal surface and is hardly peeled therefrom, or the like.

That is, the aforementioned rubber material containing silane coupling agent may often react chemically and bond with the metal surface, so that it is impossible to sufficiently inhibit or prevent adhesion of rubber to the surface only by limiting the surface roughness to a certain range and inhibiting physical adhesion as in the processing apparatus of Patent Document 1.

In addition, when the rubber material adheres to the rolling roll of the processing apparatus or the like in this way, a production line may be required to be stopped in order to peel the adhered rubber material, or maintenance works such as replacement or regrinding of the roll to which the rubber material was adhered may be required, which remarkably decreases production efficiency of the targeted rubber product. In addition, although what is most troubling is adhesion to the roll surface, there is a potential need for improving adhesion to other portions. Specifically, improvements in adhesion of the rubber material to a screw, a hopper, a mixer or a chamber of a rubber kneader, a drop door, a rotor body, or the like are desired.

### CITATION LIST

### Patent Document

Patent Document 1: JP 2004-209939

### SUMMARY OF THE INVENTION

The present invention is achieved in consideration of the aforementioned problems, and an object thereof is to provide a member in contact with a rubber material in which adhesion of the rubber material to a surface is inhibited.

A member in contact with a rubber material according to one aspect of the present invention is characterized in that the member has a surface in contact with the rubber material, and that the contact angle of the surface in contact with the rubber material is 40° or more when a liquid rubber to be tested is placed on the surface.

Objects, features and advantages of the present invention become more obvious from the following detailed description and the accompanying drawings.

### BRIEF DESCRIPTION OF THE DRAWINGS

FIG. 1 is a perspective view of a member in contact with a rubber material of the present invention.

FIG. 2 is a diagram summarizing the relationship between the contact angle to a liquid rubber and the peel strength.

FIG. 3 is an explanatory drawing explaining the peel angle.

FIG. 4 is a diagram summarizing the relationship between the contact angle to the liquid rubber and the peel angle ratio.

### DESCRIPTION OF THE EMBODIMENT

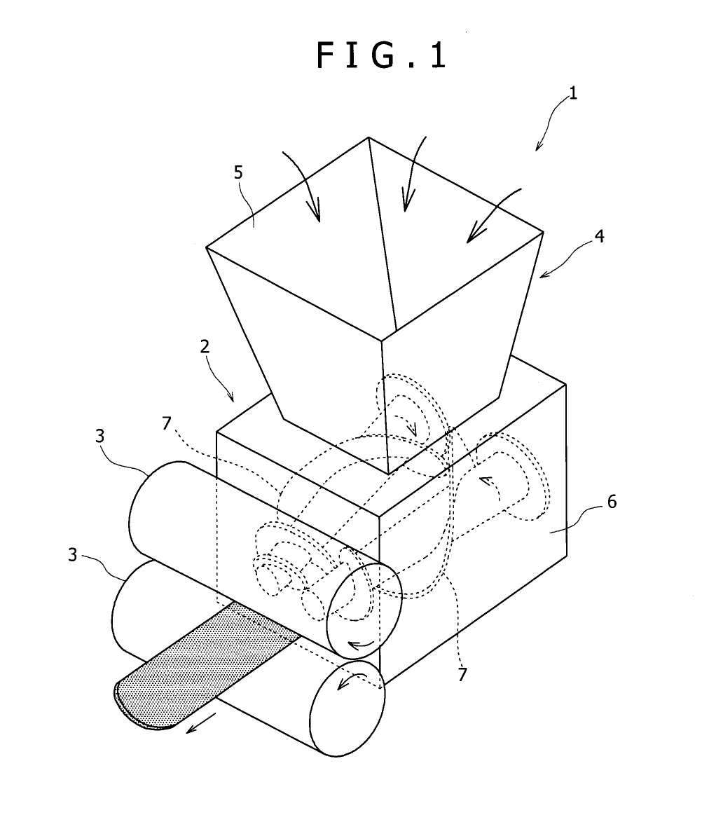

An embodiment of a member in contact with a rubber material of the present invention will be described specifically below with reference to the drawings. It should be noted that an apparatus shown in FIG. 1 is a rubber processing apparatus 1, and that it is an example of the member in contact with the rubber material. The member in contact with the rubber material of the present embodiment is not limited to that of FIG. 1.

The rubber processing apparatus 1 (the member in contact with the rubber material) of the present embodiment is a processing equipment by kneading materials such as a raw material rubber (raw rubber) used for a tire or the like, a vulcanizing agent and a vulcanizing aid, and rolling or pressing the kneaded material.

The rubber processing apparatus 1 performs a rolling process to the kneaded rubber material, and has a sending part 2 and a processing roller 3, the sending part 2 sending the rubber material kneaded in a kneading equipment (not shown) to the processing roller, and the processing roller 3 coming in contact with the rubber material sent from the sending part 2 and processing the rubber material. Above the sending part 2, a hopper 4 for charging the rubber material is provided, and through the hopper 4, the rubber material can be supplied directly to the sending part 2.

The rubber material processed by the rubber processing apparatus 1 of the present embodiment contains rubber compositions such as natural rubber, butadiene rubber, styrene butadiene rubber and chloroprene rubber, as main compositions, and contains a vulcanizing agent, a vulcanizing aid, an anti-aging agent, an antioxidant and the like, as auxiliary components. In addition, the rubber material contains silica for reinforcing a chemical structure at the time of vulcanization, and silane coupling agent for further enhancing the reinforcing effect by silica. As silane coupling agent, TESPT (Bis(triethoxysilylpropyl)polysulfide), Trimethoxysilylpropanethiol or the like can be used.

The hopper 4 is opened at an upper part and a lower part respectively, and is formed in a tapered shape so as to become narrower toward the lower part from the upper part. The lower opening of the hopper 4 is in communication with the sending part 2, and the rubber material charged into the hopper 4 from an upper opening 5 can be supplied to the sending part 2.

The sending part 2 includes a housing 6 whose inside is formed as a storage chamber of the rubber material, and a pair of feed rotors 7, 7 disposed so as to pass through the storage chamber provided inside the housing 6 and direct axial centers thereof to the horizontal direction.

These feed rotors 7, 7 have each a spiral feed flight, and the twisting direction of feed flight and the rotation direction of the one feed rotor 7 are different from the twisting direction of feed flight and the rotation direction of the other feed rotor 7 (a different direction rotary type). The pair of feed rollers 7, 7 are rotated in different directions from each other, and thereby the rubber material supplied to the storage chamber of the sending part 2 is fed to a downstream side. The rubber material thus sent from the sending part 2 is fed to the processing roller 3 and rolled.

The processing roller 3 is disposed in a direction approximately orthogonal to the aforementioned feed rotor 7, in other words, in a direction orthogonal to the feed direction of the rubber material by the sending part 2, an axial center thereof is directed to the horizontal direction, and two rollers are disposed in pairs on the upper and lower sides. These processing rollers 3, 3 are formed in a cylindrical shape of steel or stainless steel, a surface described later exists on the outer peripheral surface thereof, and this surface is polished and finished smoothly.

Between these processing rollers 3, 3, the rubber material sent from the sending part 2 is supplied. The rubber material is drawn longitudinally while being rolled vertically between these processing rollers 3, 3.

By the way, as for the metal surface of the aforementioned rubber processing apparatus of Patent Document 1, the surface roughness thereof is generally 5-50 μm so that the rubber material hardly adheres to the metal surface. If the surface roughness of the metal surface is thus 5-50 μm, it is likely that the contact area of the metal surface with the rubber material is reduced, and that the rubber material hardly adheres to the metal surface.

However, as to the aforementioned rubber material containing silane coupling agent, silane coupling agent in the rubber material may often react chemically with the metal surface such as a roll surface. Therefore, it is impossible to sufficiently prevent adhesion of the rubber material only by reducing the surface roughness of the metal surface in contact with the rubber material, in other words, only by roughening the physical shape of the metal surface in contact with the rubber material as in the case of the conventional processing apparatus.

That is, in a case where the rubber material containing silane coupling agent is used for processing, it is not enough to adopt the surface roughness of the metal surface in contact with the rubber material as an indicator for preventing adhesion of the rubber material as in the case of the conventional rubber processing apparatus, and a new evaluation indicator in place of the surface roughness has to be adopted.

Thus, in the rubber processing apparatus 1 of the present embodiment, the contact angle is adopted as a new evaluation indicator in place of the surface roughness, and the contact angle of the surface in contact with the rubber material including the outer peripheral surface of the processing roller 3 is 40° or more when a liquid rubber to be tested is placed thereon.

Specifically, the surface corresponds to a coating layer coating the surface of underlying metal such as steel or stainless steel, and is formed of metal such as iron, chromium, nickel or cobalt, or a hard material such as cermet which is a combination of these metals and ceramics or the like. The surface is formed in a film on the underlying metal by thermal spraying, build-up welding and PVD (Physical Vapor Deposition) methods or the like as described later, and has a surface condition that the contact angle thereof is 40° or more when the liquid rubber to be tested is placed thereon.

It should be noted that when the liquid rubber to be tested is placed on the surface, for example, the aforementioned contact angle is set as the angle (wetting angle) between a tangent formed on the droplet surface of the liquid rubber and the surface. Specifically, the contact angle can be measured by causing silane coupling agent to act on the surface after washing the surface with the use of organic solvent, ion-exchanged water, ultrasonic waves or the like, dropping the liquid rubber to be tested on the surface, and observing the droplet surface, and the droplets of the liquid rubber placed on the surface can be measured by using known techniques such as a θ/2 method, a curve fitting method or a tangent method.

In addition, the liquid rubber to be tested is a rubber with a particularly high viscoelasticity among the rubbers usable as the rubber material. Such rubbers include, for example, butadiene rubber, isoprene rubber, ethylene propylene rubber (EPDM), and the like. The liquid rubber to be tested is different from the rubber (rubber on ordinary grade) generally used as the rubber material in molecular weight. That is, the liquid rubber is polymerized so as to have a molecular weight smaller than that of the rubber on ordinary grade, and can be maintained in a liquid state at normal temperature (room temperature). It should be noted that the rubber on ordinary grade often has a molecular weight more than 20000. Specific examples of such liquid rubber to be tested include butadiene rubber synthesized (polymerized) by reducing the molecular weight to 10000 or less, or the like. By using such liquid rubber, a test environment is not necessary to set to high temperature and high pressure in order to maintain a plastic state of the rubber material, and it is possible to evaluate adhesive property of the rubber material without using a large-scale equipment. In the present application, butadiene rubber “LBR307” made by KURARAY CO., LTD., for example, can be used.

As mentioned above, in the member (for example, the processing roller 3) having a surface in contact with the rubber material, if the surface is in the surface condition that the contact angle thereof is 40° or more when the liquid rubber to be tested is placed thereon, the rubber material hardly adheres to the surface. In other words, if the contact angle of the member surface is 40° or more, the rubber material hardly remains adhered to the surface, and even if the rubber material adheres to the surface in contact with the rubber material, the rubber material is easily peeled therefrom.

For example, in the case of the conventional rubber processing apparatus, the peel strength more than 6 kgf/25 mm is required to peel the rubber material from the surface of the processing roller or the like. However, if the contact angle of the member surface is 40° or more, the peel strength is significantly reduced to 4 kgf/25 mm or less, and compared to the case where the rubber material adhered to the conventional processing roller or the like is peeled, it is easier to peel the adhered rubber material, and adhesive property of the rubber material is reduced.

In addition, in the measurement of the contact angle, a measuring instrument is not required to be separately prepared as is the case for the measurement of the peel strength, and convenience is also excellent because adhesion evaluation of the rubber material can be easily performed with a simple equipment like a general-purpose contact angle meter.

It should be noted that the contact angle of the surface in contact with the rubber material can be 40° or more specifically by performing the following surface treatment method, for example.

### (1) Formation of Surface Treatment Layer by Build-up Welding

A surface treatment layer is formed on a metal surface in contact with a rubber material by forming a hard metal layer composed of steel, stainless steel, chromium or the like by build-up welding, and thereby the contact angle of the surface in contact with the rubber material can be 40° or more. It should be noted that a surface of the hard metal layer is preferably polished as necessary.

### (2) Formation of Surface Treatment Layer by Thermal Spraying

A surface treatment layer is formed on a metal surface in contact with a rubber material by forming a hard metal layer composed of cermet or the like by thermal spraying, and thereby the contact angle of the surface in contact with the rubber material can be 40° or more.

### (3) Formation of Surface Treatment Layer by Plating

A surface treatment layer is formed on a metal surface in contact with a rubber material by forming a hard metal layer by plating, and thereby the contact angle of the surface in contact with the rubber material can be 40° or more. Such plating includes hard chromium plating, nickel electroplating, nickel electroless plating or the like.

The surfaces of these hard metal layers formed by welding, thermal spraying and plating have each the contact angle of 40° or more on their own or by polishing. In addition, if the contact angle of only the hard metal layer is less than 40°, it is preferable that a mold release promoting layer for promoting mold release of the rubber material is further applied (coated) to the surface of the hard metal layer. Mold release promoting agents include wax, or talc, mica, polyethylene glycol, fluorine-based resin, silicon-based resin, or the like.

In particular, the surface of the hard metal layer formed by thermal spraying has a plurality of irregularities formed thereon, and often has a porous film quality. Therefore, if the aforementioned mold release promoting agent is applied to the surface of the hard metal layer on which the plurality of irregularities are formed, by a physical anchor effect between the irregularities of the surface and the mold release promoting layer formed by the applied mold release promoting agent, the surface of the hard metal layer can be adhesively coated with the mold release promoting layer.

In addition, in a case where the hard metal layer is formed by using plating or the like whose surface has relatively less irregularities, if the surface of the hard metal layer is intentionally roughened by using shot blast or laser, the surface of the hard metal layer can be adhesively coated with the mold release promoting layer as is the case for thermal spraying.

### (4) Formation of Surface Treatment Layer (Composite Plating Layer) by Composite Plating Containing Mold Release Promoting Particles

On a metal surface in contact with a rubber material, a surface treatment layer may be formed by forming a hard metal layer by composite plating. Plating baths used in forming this composite plating contain fine particles of the aforementioned mold release promoting agent for promoting mold release of the rubber material, and if these plating baths are used in performing composite plating, the hard metal layer also will contain mold release promoting particles.

It should be noted that the aforementioned surface treatment methods of (1)-(4) are an example of methods of forming a surface whose contact angle is 40° or more, and that these methods can be used appropriately according to the intended use or the type of underlying metal.

Technical features of the above member in contact with the rubber material will be summarized below.

The member in contact with the rubber material according to one aspect of the present invention is characterized in that the member has a surface in contact with the rubber material, and that the contact angle of the surface thereof in contact with the rubber material is 40° or more when a liquid rubber to be tested is placed on the surface. According to the member in contact with the rubber material of the present invention, adhesion of the rubber material on the surface is inhibited.

The liquid rubber to be tested is preferably composed of butadiene rubber which is liquefied at normal temperature. As for such liquid rubber, a test environment is not necessary to set to high temperature and high pressure in order to maintain a plastic state thereof, so that it is possible to evaluate adhesive property thereof without using a large-scale equipment.

The member in contact with the rubber material according to another aspect of the present invention is characterized in that the member has a surface in contact with the rubber material, and that the contact angle thereof is 40° or more when a liquid rubber to be tested is placed on the surface thereof after causing silane coupling agent to act on the surface.

According to the member in contact with the rubber material of the present invention, adhesion of the rubber material on the surface is sufficiently inhibited even if causing silane coupling agent to act on the surface thereof.

The member in contact with the rubber material according to the other aspect of the present invention is characterized in that the member has a surface in contact with the rubber material, and that the contact angle thereof is 40° or more when a liquid rubber to be tested composed of butadiene rubber which is liquefied at normal temperature is placed on the surface thereof after causing silane coupling agent to act on the surface.

According to the member in contact with the rubber material of the present invention, adhesion of the rubber material on the surface is sufficiently inhibited even if causing silane coupling agent to act on the surface thereof. In addition, as for such liquid rubber, a test environment is not necessary to set to high temperature and high pressure in order to maintain a plastic state thereof, so that it is possible to evaluate adhesive property thereof without using a large-scale equipment.

As for the surface in contact with the rubber material, the contact angle thereof is easy to be 40° or more by providing a hard metal layer formed by build-up welding thereon.

On the surface in contact with the rubber material, a hard metal layer whose surface is formed porously, and a mold release promoting layer for coating and sealing the surface of the hard metal layer formed porously and promoting mold release of the rubber material are preferably provided. On the surface of the hard metal layer, the mold release promoting layer is adhesively provided by a physical anchor effect. The rubber material hardly adheres to the surface provided with the mold release promoting layer more.

On the surface in contact with the rubber material, a composite plating layer of hard metal containing mold release promoting particles for promoting mold release of the rubber material is preferably formed. By providing such composite plating layer, the rubber material hardly adheres to the surface in contact with the rubber material more.

The member in contact with the rubber material is preferably a processing roller in a rubber processing apparatus having a sending part sending the kneaded rubber material, and the processing roller coming in contact with the rubber material sent from the sending part and processing the rubber material. In this case, adhesion of the rubber material to the processing roller is inhibited.

### EXAMPLES

Next, with reference to examples and comparative examples, operation and effects of the member in contact with the rubber material of the present invention will be described in detail.

### Experimental Example 1

Test pieces were prepared by performing the respective processings shown in Table 1 to iron plate materials cut into a thickness of 50 mm×150 mm×5 mm.

TABLE 1

| | Processing content | | Peel strength |
|---|---|---|---|
| Comparative example 1 | Hard chromium plating | | 6.24 |
| Comparative example 2 | Hard chromium plating, Shot blast | | 9.48 |
| Comparative example 3 | Cermet thermal spraying | | 6.11 |
| Example 1 | Build-up welding → Polishing | Material compositions are different and Fe | 3.33 |
| Example 2 | Build-up welding → Polishing | concentration increases in the order of | 1.93 |
| Example 3 | Build-up welding → Polishing | Examples 1, 2, 3 | 1.87 |

| | | |
|---|---|---|
| Example 4 | Chromium plating → Porous formation on surface → Application of mold release promoting agent | 0.72 |
| Example 5 | NiP plating containing mold release promoting particles | 0.27 |
| Example 6 | Underlying metal coating → Shot blast →Application of mold release promoting agent | 0.17 |
| Example 7 | Underlying metal coating → Porous formation by laser irradiation → Application of mold release | 0.086 |
| | promoting agent | |
| Example 8 | Cermet thermal spraying →Application of mold release promoting agent | 0.11 |

(kgf/25 mm)

### Comparative Example 1, Comparative example 2

The test piece of Comparative example 1 was prepared by performing hard chromium plating having a film thickness of 30-50 μm on a surface of the iron plate material and then slightly grinding and smoothing the plated surface. The test piece of Comparative example 2 was prepared by performing hard chromium plating and shot blast on a surface of the iron plate material and then roughening a surface of a hard metal layer.

### Comparative Example 3

The test piece of Comparative example 3 was prepared by performing thermal spraying of cermet composed of tungsten carbide and cobalt on a surface of the iron plate material so as to have a thickness of 200 μm and then slightly grinding the thermal sprayed surface without providing a mold release promoting layer on the surface.

### Examples 1-3

The test pieces of Examples 1-3 were prepared by performing build-up welding of different metal materials in a thickness of 3000 μm on each surface of the iron plate materials respectively and then slightly grinding and smoothing the welded surface. Welding materials composed of iron or the like were used as the metal materials. Concentration of iron in the welding materials increases in the order of Example 1, Example 2 and Example 3.

### Example 4

The test piece of Example 4 was prepared by forming chromium plating in film in a thickness of 50-70 μm on a surface of the iron plate material and then roughening a surface of a hard metal layer of chromium formed. Roughening was performed by quenching the hard metal layer after heating, and thus forming cracks on the hard metal layer due to rapid temperature change. Then, the test piece was further prepared by applying mold release promoting agent to the roughened surface and forming a mold release promoting layer thereon.

### Example 5

The test piece of Example 5 was prepared by performing nickel phosphorous plating containing mold release promoting particles in a thickness of 20 μm on a surface of the iron plate material and forming a surface treatment layer thereon.

### Example 6

The test piece of Example 6 was prepared by coating underlying metal on a surface of the iron plate material, roughening a surface of the coating underlying metal by shot blast, applying mold release promoting agent to the roughened surface, and forming a mold release promoting layer thereon.

### Example 7

The test piece of Example 7 was prepared by coating underlying metal on a surface of the iron plate material, roughening a surface of the coating underlying metal by laser irradiation, applying mold release promoting agent to the roughened surface, and forming a mold release promoting layer thereon.

### Example 8

The test piece of Example 8 was prepared by performing thermal spraying of cermet composed of tungsten carbide and cobalt on a surface of the iron plate material so as to have a thickness of 200 μm, applying mold release promoting agent on the thermal sprayed surface, and forming a mold release promoting layer thereon.

Wax, or talc, mica, polyethylene glycol, fluorine-based resin, silicon-based resin, or the like were used as the mold release promoting agents and the mold release promoting particles of the aforementioned Comparative examples 1-3 and Examples 1-8.

As to the respective test pieces of the aforementioned Comparative examples 1-3 and Examples 1-8, the contact angle was measured.

Prior to measurement, the test pieces were treated by applying ultrasonic waves thereto as a pretreatment, and simultaneously removing oil and fat therefrom using acetone, and washing the surface using deionized water until it becomes hydrophilic. The washed test pieces were completely dried, and a solution of silane coupling agent were caused to act on the surface by the following methods.

As the solution of silane coupling agent, a solution containing 5% of silane coupling agent (“Si69” made by EVONIK INDUSTRIES AG) consisting primarily of TESPT, 5% of ion-exchanged water, and 90% of ethanol was used. The test pieces were immersed in the solution for 10 seconds and dried for 1 hour in an atmosphere of 100C°, a liquid rubber (butadiene rubber “LBR307” made by KURARAY CO., LTD.) was dropped on the dried test pieces, and the contact angle of droplets of the liquid rubber was measured by using a contact angle meter (“FACE CA-A type” manufactured by Kyowa Interface Science Co., LTD.).

As to the respective test pieces of the aforementioned Comparative examples 1-3 and Examples 1-8, the peel strength was measured. The peel strength was measured as follows. A rubber sheet (containing 96 parts by weight of styrene butadiene rubber (SBR), 30 parts by weight of butadiene rubber (BR), 80 parts by weight of silica, 6.4 parts by weight of silane coupling agent, 3 parts by weight of zinc oxide, 2 parts by weight of stearic acid, 1.5 parts by weight of an anti-aging agent, and 1 parts by weight of an antioxidant) cut into 25 mm width×420 mm length was attached to the test pieces by pressure of 3 kg/cm² for 10 minutes at 160° C. by using a molding machine (an NF-50 type single-acting compression molding machine manufactured by SHINTO Metal Industries Corporation). Then, after cooling at room temperature, the rubber sheet attached by pressure was peeled by using a tensile testing machine (MODEL SL-2000 manufactured by IMADA-SS Corporation) at an angle of 180° at room temperature at 50 mm/min, and the peel strength was calculated.

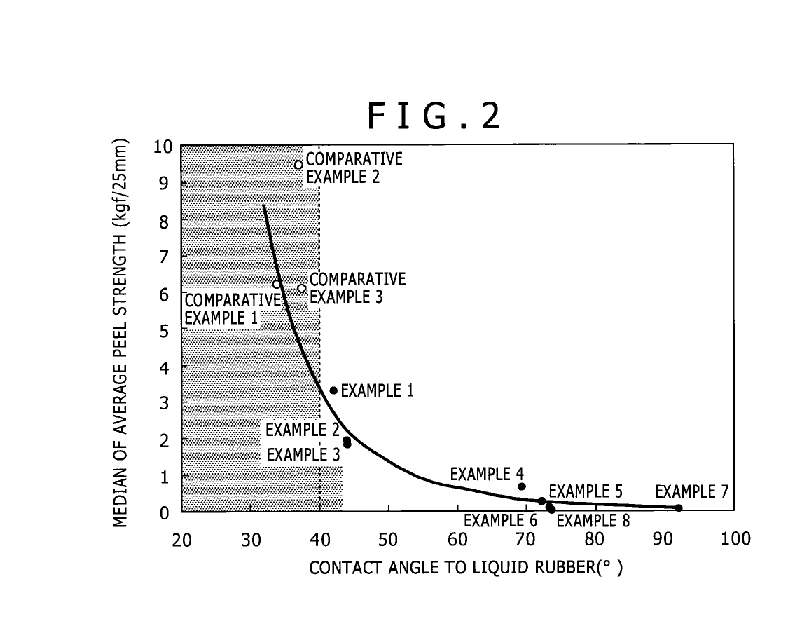

The relationship between the contact angle and the peel strength measured as mentioned above is summarized in FIG. 2. As shown by a bold line in FIG. 2, between the contact angle and the peel strength, a correlation in which the peel strength is reduced as the contact angle is increased was revealed.

In addition, according to the correlation, whereas the peel strength of Comparative example 1 having a contact angle of less than 40° was 24 kgf/25 mm, the peel strength of Example 1 having a contact angle of 40° or more was significantly reduced to 4 kgf/25 mm or less. It was found that if the contact angle is 40° or more, the rubber material can be peeled at a peel strength about half the conventional peel strength, and it was determined that adhesion of the rubber material to a processing roller or the like can be prevented.

### Experimental Example 2

Rolling rolls to which the same processings as the processings for preparing the test pieces of Comparative example 1 and Examples 4, 7, 8 were performed, were prepared. The kneaded rubber was adhered to the surface of the respective rolling rolls, and the peel angle in peeling the adhered rubber from the surface of the rolling rolls was measured.

Specifically, the steel rolling rolls were subjected to the respective processings shown in Table 1, and the same silane coupling agent (Si69) used in Experimental Example 1 was caused to act on the processed surface.

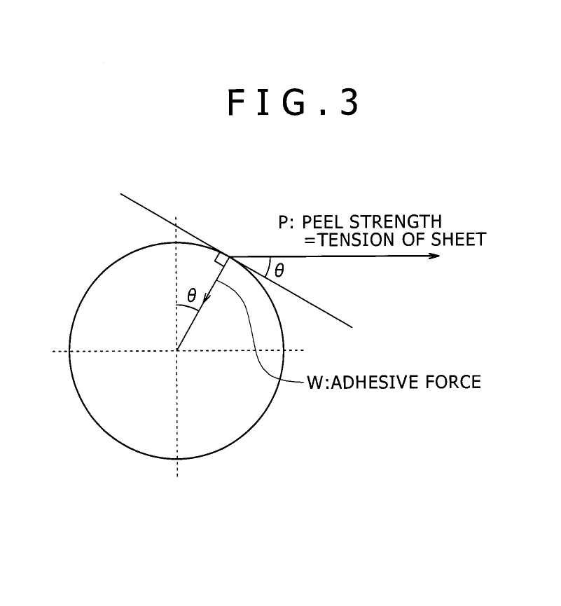

The peel strength can be also expressed as the peel angle θ in peeling the rubber. That is, as shown in FIG. 3, the peel angle θ is shown as the following equation (1) using the adhesive force W and the peel strength P.

W=P (1 - cos θ) (1)

From this equation (1), if the peel strength P is constant, the adhesive force W is determined by only the peel angle θ obtained from the experiment, so that the magnitude of the adhesive force W can be compared if the value of the peel angle θ is known.

The same rubber sheet used in measuring the peel strength in Experimental Example 1 was kneaded by using a twin-screw extrusion kneader (HYPER KTX30 manufactured by KOBE STEEL, LTD.), and the kneaded rubber sheet was rolled by the aforementioned rolling roll to which the processings shown in Table 1 were performed. It should be noted that the hot water set temperature of the rolling roll is 60° C. and the number of revolutions thereof is about 8-9 rpm.

As shown in FIG. 3, a tension in the just lateral direction is applied to the sheet coming out of the rolling roll, and image analysis of the peeled state of the sheet from the roll surface was performed.

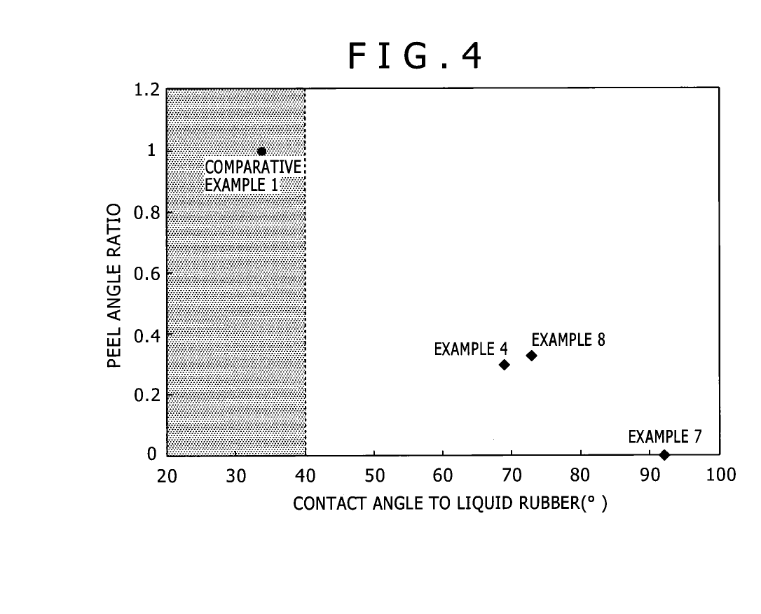

As shown in FIG. 4, the rolling rolls of Examples 4, 7, 8 including a surface treatment layer whose contact angle to the liquid rubber is 40° or more had a peel angle ratio (obtained by dividing the measured peel angle by the peel angle measured by using the rolling roll of Example 1) smaller than that of the rolling roll of Comparative example 1 having a contact angle of 40° or less. From this, it was found that if the contact angle to the liquid rubber is 40° or more, adhesion of rubber hardly occurs also in the aforementioned continuous test.

It should be noted that the embodiment disclosed herein should be considered to be illustrative and not restrictive in every respect. In particular, in the embodiment disclosed herein, the matters which are not explicitly disclosed, such as the running condition and the operating condition, the various parameters, the dimension, weight, volume of the components and the like, do not depart from the scope ordinarily implemented by those of skill in the art, and the values that can be readily contemplated by those of ordinary skill in the art are adopted.

### INDUSTRIAL APPLICABILITY

According to the member of the present invention, adhesion of the rubber material to the surface is inhibited, so that the member can be widely used in the technical field such as the member in contact with the rubber material (for example, the processing roller of the rubber processing apparatus) in performing a processing such as kneading or rolling of rubber.

1. A member in contact with a rubber material, wherein the member has a surface in contact with the rubber material, and a contact angle of the surface thereof in contact with the rubber material is 40° or more when a liquid rubber to be tested is placed on the surface.

2. The member in contact with the rubber material according to claim 1, wherein the liquid rubber to be tested comprises butadiene rubber which is liquefied at normal temperature.

3. A member in contact with a rubber material, wherein the member has a surface in contact with the rubber material, and a contact angle thereof is 40° or more when a liquid rubber to be tested is placed on the surface thereof after causing a silane coupling agent to act on the surface.

4. A member in contact with a rubber material, wherein the member has a surface in contact with the rubber material, and a contact angle thereof is 40° or more when a liquid rubber to be tested comprising butadiene rubber which is liquefied at normal temperature is placed on the surface thereof after causing a silane coupling agent to act on the surface.

5. The member in contact with the rubber material according claim 1, wherein a hard metal layer formed by build-up welding is provided on the surface thereof in contact with the rubber material.

6. The member in contact with the rubber material according to claim 1, wherein on the surface thereof in contact with the rubber material, a hard metal layer whose surface is formed porously, and a mold release promoting layer are provided for coating and sealing the surface of the hard metal layer formed porously and promoting mold release of the rubber material.

7. The member in contact with the rubber material according to claim 1, wherein on the surface thereof in contact with the rubber material, a composite plating layer of hard metal comprising mold release promoting particles is formed for promoting mold release of the rubber material.

8. The member in contact with the rubber material according to claim 1, wherein the member is a processing roller in a rubber processing apparatus comprising a sending part, which sends the rubber material, and the processing roller comes in contact with the rubber material sent from the sending part and processes the rubber material.
